(19) United States
(12) Patent Application Publication
(10) Pub. No.: US 2018/0137818 A1
(43) Pub. Date: May 17, 2018

(54) DISPLAY PANEL AND DISPLAY DEVICE

(71) Applicant: SAMSUNG DISPLAY CO., LTD., Yongin-si (KR)

(72) Inventors: Hyojung KIM, Suwon-si (KR); June Hwan KIM, Asan-si (KR); Daeyoun CHO, Yongin-si (KR)

(21) Appl. No.: 15/728,309

(22) Filed: Oct. 9, 2017

(30) Foreign Application Priority Data
Nov. 15, 2016 (KR) 10-2016-0152224

(51) Int. Cl. G09G 3/3233; G09G 3/20; G09G 3/3266; G09G 3/3275

(52) U.S. Cl. CPC G09G 3/3233; G09G 3/2003; G09G 3/3266; G09G 2310/08; G09G 2330/02; G09G 2340/0407; G09G 3/3275

(57) ABSTRACT

A display panel may comprise a first pixel including a first light emitting diode for emitting light based on a first current received from a first power voltage, a second pixel including a second light emitting diode for emitting light based on a second current received from the first power voltage, and a common transistor forming a first current path through which the first current flows between a first power source for supplying the first power voltage and the first light emitting diode, and forming a second current path through which the second current flows between the first power source and the second light emitting diode, in response to an emission control signal.

### CROSS REFERENCE TO RELATED APPLICATION

This application claims priority to, and the benefit of, Korean Patent Application No. 10-2016-0152224, filed on Nov. 15, 2016 in the Korean Intellectual Property Office (KIPO), the disclosure of which is hereby incorporated by reference herein in its entirety.

### BACKGROUND

### 1. Field

Embodiments of the inventive concept relate to display devices and display panels.

### 2. Discussion of Related Art

A pixel includes a light emitting element and a driving transistor for providing a driving current to the light emitting element. A display device including the pixel adjusts the driving current to display an image.

When a display device is applied to a smart phone, to a head mounted display device, or the like, then a display device having a relatively higher resolution (or pixel per inch, PPI) may be beneficial.

### SUMMARY

Embodiments provide a display panel having an improved resolution, and also provide a display device having the display panel.

According to embodiments, a display panel may comprise a first pixel including a first light emitting diode for emitting light based on a first current received from a first power voltage, a second pixel including a second light emitting diode for emitting light based on a second current received from the first power voltage, and a common transistor forming a first current path through which the first current flows between a first power source for supplying the first power voltage and the first light emitting diode, and forming a second current path through which the second current flows between the first power source and the second light emitting diode, in response to an emission control signal.

The first pixel may include a first storage capacitor, a first transistor to control the first current applied to the first light emitting diode in response to a voltage stored in the first storage capacitor, and a second transistor to transmit a first data signal to the first storage capacitor in response to a first gate signal.

The first pixel may further include a third transistor including a first electrode connected to a second electrode of the first transistor, a second electrode connected to an end of the first storage capacitor, and a gate electrode for receiving the first gate signal, a fourth transistor including a first electrode for receiving an initialization voltage, a second electrode connected to the end of the first storage capacitor, and a gate electrode for receiving a first initialization signal, a fifth transistor including a first electrode connected to the second electrode of the first transistor, a second electrode connected to an anode electrode of the first light emitting diode, and a gate electrode for receiving the emission control signal, and a sixth transistor including a first electrode connected to the anode electrode of the first light emitting diode, a second electrode for receiving the initialization voltage, and a gate electrode for receiving a first bypass signal, wherein the second transistor includes a first electrode for receiving the first data signal, a second electrode connected to a first electrode of the first transistor, and a gate electrode for receiving the first gate signal, and wherein the common transistor includes a first electrode connected to the first power source, a second electrode connected to the first electrode of the first transistor, and a gate electrode for receiving the emission control signal.

The second pixel may further include a second storage capacitor, a first transistor to control the second current applied to the second light emitting diode in response to a voltage stored in the second storage capacitor, and a second transistor to transmit a second data signal to the second storage capacitor in response to a second gate signal, wherein the second gate signal is different from the first gate signal.

The first pixel and the second pixel may be included in the same pixel row, wherein the first light emitting diode of the first pixel emits first color light, and wherein the second light emitting diode of the second pixel emits second color light that is different from the first color light.

The first pixel and the second pixel may be included in the same pixel row, wherein the first light emitting diode and the second light emitting diode emit light of a first color.

The first pixel and the second pixel may be included in a first pixel row, wherein the first gate signal is provided to the first pixel through a first gate line, and wherein the second gate signal is provided to the second pixel through a second gate line that is different from the first gate line.

The first gate line may correspond to the first pixel row, and the second gate line may correspond to a second pixel row that is adjacent to the first pixel row.

The first pixel and the second pixel may be included in a first pixel column, and the first data signal and the second data signal may be transmitted through a first data line corresponding to the first pixel column.

The display panel may further include a third pixel including a third light emitting diode for emitting light based on a third current received from the first power voltage, wherein the common transistor forms a third current path through which the third current flows between the first power source and the third light emitting diode in response to the emission control signal.

According to embodiments, a display device may comprise a display device, comprising a display panel including a first pixel having a first light emitting diode for emitting light based on a first current corresponding to a first data signal, a second pixel having a second light emitting diode for emitting light based on a second current corresponding to a second data signal, and a common transistor, a data driver to provide the first data signal to the first pixel, and to provide the second data signal to the second pixel, and a gate driver to provide a first gate signal to the first pixel, to provide a second gate signal to the second pixel, and to provide an emission control signal to the common transistor, wherein the common transistor forms a first current path through which the first current flows between a first power source of a first power voltage and the first light emitting diode, and forms a second current path through which the second current flows between the a first power source and the second light emitting diode, in response to the emission control signal.

The first pixel may include a first storage capacitor, a first transistor to control the first current applied to the first light emitting diode in response to a voltage stored in the first storage capacitor, and a second transistor to transmit the first data signal to the first storage capacitor in response to the first gate signal.

The first pixel may further include a third transistor including a first electrode connected to a second electrode of the first transistor, a second electrode connected to an end of the first storage capacitor, and a gate electrode for receiving the first gate signal, a fourth transistor including a first electrode for receiving an initialization voltage, a second electrode connected to the end of the first storage capacitor, and a gate electrode for receiving a first initialization signal, a fifth transistor including a first electrode connected to the second electrode of the first transistor, a second electrode connected to an anode electrode of the first light emitting diode, and a gate electrode for receiving the emission control signal, and a sixth transistor including a first electrode connected to the anode electrode of the first light emitting diode, a second electrode for receiving the initialization voltage, and a gate electrode for receiving a first bypass signal, wherein the second transistor includes a first electrode for receiving the first data signal, a second electrode connected to a first electrode of the first transistor, and a gate electrode for receiving the first gate signal, and wherein the common transistor includes a first electrode connected to the first power source, a second electrode connected to the first electrode of the first transistor, and a gate electrode for receiving the emission control signal.

The second pixel may further include a second storage capacitor, a first transistor to control the second current applied to the second light emitting diode in response to a voltage stored in the second storage capacitor, and a second transistor to transmit the second data signal to the second storage capacitor in response to the second gate signal, wherein the second gate signal is different from the first gate signal.

The first pixel and the second pixel may be included in the same pixel row, wherein the first light emitting diode of the first pixel emits light of a first color, and wherein the second light emitting diode of the second pixel emits light of a second color that is different from the first color.

The first pixel and the second pixel may be included in the same pixel row, wherein the first light emitting diode and the second light emitting diode emit light of a first color.

The first pixel and the second pixel may be included in a first pixel row, wherein the first gate signal is provided to the first pixel through a first gate line, and wherein the second gate signal is provided to the second pixel through a second gate line that is different from the first gate line.

The data driver may be for outputting the second data signal by delaying the second data signal by a reference time with respect to the first data signal.

The first pixel and the second pixel may be included in a first pixel column, and the first data signal and the second data signal may be transmitted through a first data line corresponding to the first pixel column.

The display panel may further include a third pixel including a third light emitting diode for emitting light based on a third current received from the first power voltage, and the common transistor may form a third current path through which the third current flows between the first power source and the third light emitting diode in response to the emission control signal.

Therefore, the display panel according to embodiments may include the common transistor to form the first and second current paths for the first and second pixels (e.g., the first pixel and the second pixel share the common transistor) so that components for the first and second pixels may be reduced. Thus, sizes and areas of the first and second pixels may be reduced, and resolution of the display panel may be improved.

In addition, because the display device may include the display panel, the display device may display images with improved resolution.

### BRIEF DESCRIPTION OF THE DRAWINGS

Embodiments can be understood in more detail from the following description taken in conjunction with the accompanying drawings, in which:

FIG. 1 is a block diagram of a display device according to embodiments;

FIGS. 2A and 2B are circuit diagrams illustrating an example of pixels included in the display device of FIG. 1;

FIG. 3 is a timing diagram for explaining an operation of the pixels of FIG. 2A;

FIG. 4 is a diagram illustrating a display panel included in the display device of FIG. 1;

FIG. 5 is a circuit diagram illustrating an example of pixels included in the display panel of FIG. 4;

FIG. 6A is a diagram illustrating an example of a connection structure of pixels included in the display panel of FIG. 4; and

FIG. 6B is a diagram illustrating an example of a data signal provided to the display panel of FIG. 4.

### DETAILED DESCRIPTION

Features of the inventive concept and methods of accomplishing the same may be understood more readily by reference to the following detailed description of embodiments and the accompanying drawings. Hereinafter, embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

In the following description, for the purposes of explanation, numerous specific details are set forth to provide a thorough understanding of various embodiments. It is apparent, however, that various embodiments may be practiced without these specific details or with one or more equivalent arrangements. In other instances, well-known structures and devices are shown in block diagram form in order to avoid unnecessarily obscuring various embodiments.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element, layer, region, or component is referred to as being “on,” “connected to,” or “coupled to” another element, layer, region, or component, it can be directly on, connected to, or coupled to the other element, layer, region, or component, or one or more intervening elements, layers, regions, or components may be present. However, “directly connected/directly coupled” refers to one component directly connecting or coupling another component without an intermediate component. In addition, it will also be understood that when an element or layer is referred to as being “between” two elements or layers, it can be the only element or layer between the two elements or layers, or one or more intervening elements or layers may also be present.

For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

In the following examples, the x-axis, the y-axis and the z-axis are not limited to three axes of a rectangular coordinate system, and may be interpreted in a broader sense. For example, the x-axis, the y-axis, and the z-axis may be perpendicular to one another, or may represent different directions that are not perpendicular to one another.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

When a certain embodiment may be implemented differently, a specific process order may be performed differently from the described order. For example, two consecutively described processes may be performed substantially at the same time or performed in an order opposite to the described order.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Various embodiments are described herein with reference to sectional illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

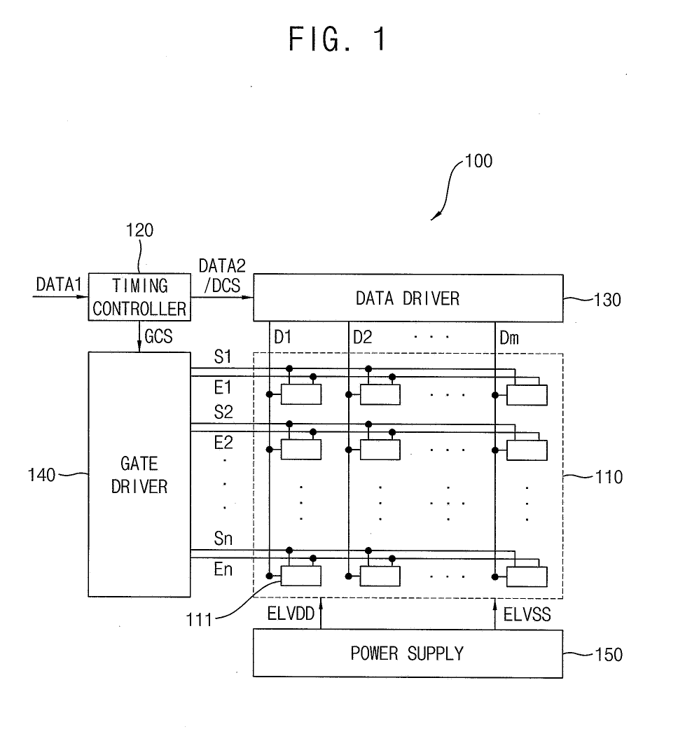

FIG. 1 is a block diagram of a display device according to embodiments.

Referring to FIG. 1, the display device 100 may include a display panel 110, a timing controller 120, a data driver 130, a gate driver 140, and a power supply 150. The display device 100 may output an image based on externally supplied input data (e.g., first data DATA1). For example, the display device 100 may be an organic light emitting display device.

The display panel 110 may include a plurality of gate lines S1 to Sn, a plurality of data lines D1 to Dm, a plurality of emission control lines E1 to En, and a plurality of pixels 111, where n and m are positive integers that are greater than 1. The pixels 111 may be disposed in intersections of the gate lines SL1 to Sn and the data lines D1 to Dm, respectively.

Each of the pixels 111 may include a light emitting diode. The pixels 111 may respectively store a data signal provided through the data lines D1 to Dm in response to a gate signal provided through the gate lines S1 to Sn, and may control a driving current flowing into the light emitting diode based on the data signal. The pixels 111 may emit light at a luminance corresponding to the driving current (or the data signal) in response to an emission control signal provided through the emission control lines E1 to En.

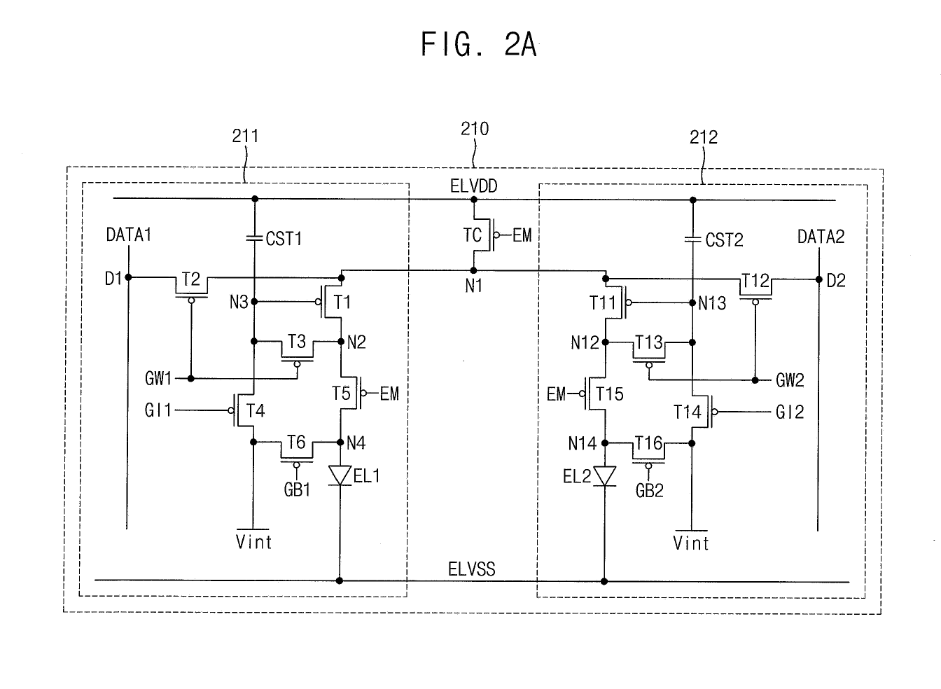

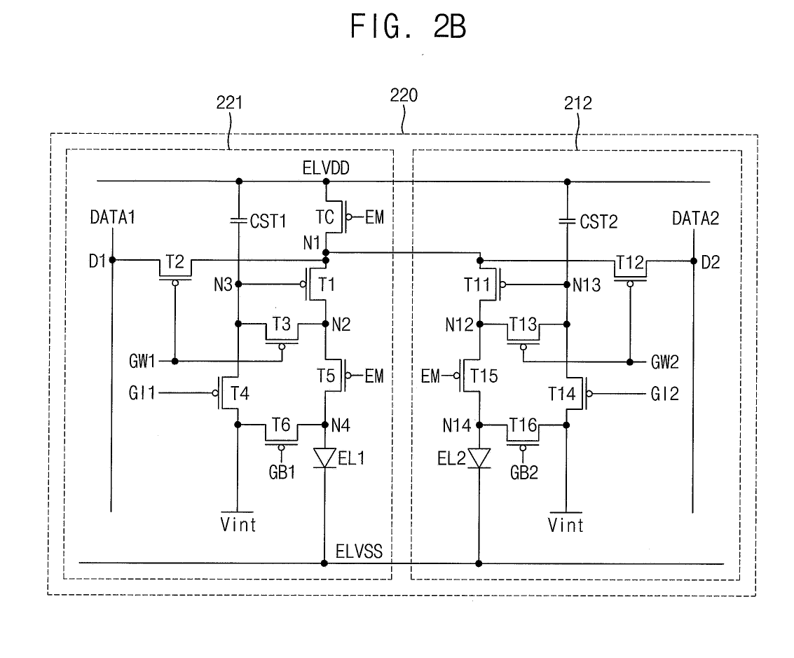

In some embodiments, two or more of the pixels 111 may constitute one pixel unit, and may share a light emitting transistor. Here, the light emitting transistor may form a current path for supplying the driving current to the light emitting diodes of the at least two pixels 111 from the power supply 150. That is, each of the at least two pixels 111 in the pixel unit may receive driving currents through one light emitting transistor. A configuration in which at least two pixels share the light emitting transistor will be described with reference to FIG. 2.

The timing controller 120 may convert externally supplied image data (e.g., first data DATA1) that is received from an external device, such as a graphic device, into usable data (e.g., second data DATA2) for the display panel 110. For example, the timing controller 120 may convert RGB format image data into RGBG format data. The timing controller 120 may control the data driver 130 and the gate driver 140. The timing controller 120 may generate a gate control signal GCS and a data control signal DCS to respectively control the gate driver 140 and the data driver 130.

The data driver 130 may generate a plurality of gamma voltages and the data signal using the second data DATA2, and may apply the data signal to the display panel 110 (e.g., to respective ones of the pixels 111). The data driver 130 may apply the data signal to the display panel 110 in response to the data control signal DCS.

The gate driver 140 may generate the gate signal based on the gate control signal GCS. The gate control signal GCS may include a start pulse and clock signals. The gate driver 140 may include a shift register that sequentially generates gate signals corresponding to the start pulse and the clock signals.

The gate driver 140 may generate the emission control signal based on the gate control signal GCS, and may apply the emission signal to the pixels 111 through the emission control lines El to En. The gate driver 140 may determine an on-duty (emission period) and/or an off-duty (non-emission period) based on a control signal. The pixels 111 may emit light in response to the emission control signal having a logical low level (or, having a low voltage or a turn-on voltage).

The power supply 150 may generate a driving voltage for driving the display device 100. The driving voltage may include a first power voltage ELVDD and a second power voltage ELVSS. The first power voltage ELVDD may be greater than the second power voltage ELVSS.

FIGS. 2A and 2B are circuit diagrams illustrating an example of pixels included in the display device of FIG. 1.

Referring to FIG. 2A, the display panel 110 (or a pixel unit 210) may include a first pixel 211, a second pixel 212, and a common transistor TC. The first pixel 211 and the second pixel 212 may be two pixels of the display panel 110 of FIG. 1.

The common transistor TC may include a first electrode connected to a first power source for applying a first power voltage ELVDD, a second electrode connected to a first node N1, and a gate electrode for receiving an emission control signal EM. The common transistor TC may form a current path between the first and second pixels 211 and 212 in response to the emission control signal EM. That is, the first pixel 211 and the second pixel 212 may be connected to the first power source via the common transistor TC.

The first pixel 211 may include a first light emitting diode EL1, a first storage capacitor CST1, and six transistors T1 to T6.

The first light emitting diode EL1 may be connected between the first power source (or a fourth node N4) and a second power source for applying a second power voltage ELVSS. The first light emitting diode EL1 may emit light based on a first driving current flowing through the fourth node N4. Here, the first and second power voltages ELVDD and ELVSS may be provided from the power supply 150. The first light emitting diode EL1 may be an organic light emitting diode.

The second transistor T2 may include a first electrode connected to a first data line D1, a second electrode connected to a first node N1, and a gate electrode for receiving a first gate signal GW1. The second transistor T2 may transmit a first data signal DATA1 received from the first data line D1 to the first node N1 in response to the first gate signal GW1.

The first transistor T1 may include a first electrode connected to the first node N1, a second electrode connected to a second node N2, and a gate electrode connected to a third node N3. The first transistor may control the first driving current applied to the first light emitting diode EL1 in response to a third node voltage (e.g., a voltage charged in the first storage capacitor CST1.

The third transistor T3 may include a first electrode connected to the second node N2, a second electrode connected to the third node N3, and a gate electrode for receiving the first gate signal GW1. The third transistor T3 may electrically connect the second node N2 and the third node N3 in response to the first gate signal GW1.

The first storage capacitor CST1 may be connected between the first power source and the third node N3. The first storage capacitor CST1 may store the first data signal DATA1 provided through the first to third transistors T1 to T3.

The fourth transistor T4 may include a first electrode connected to an initialization voltage line for transmitting an initialization voltage Vint, a second electrode connected to the third node N3, and a gate electrode for receiving a first initialization signal G11. The fourth transistor T4 may transmit the initialization voltage Vint to the first storage capacitor CST1 (and/or to the gate electrode of the first transistor T1) in response to the first initialization signal G11. Then, a voltage stored in the first storage capacitor CST1 may be initialized by the initialization voltage Vint.

The fifth transistor T5 may include a first electrode connected to the second node N2, a second electrode connected to the fourth node N4, and a gate electrode for receiving the emission control signal EM. The fifth transistor T5 may form the first current path between the second node N2 and the first light emitting diode EU in response to the emission control signal EM. Because the common transistor TC is also turned on by the emission control signal EM, the fifth transistor T5 and the common transistor TC may form the first current path between the first power source and the first light emitting diode EL1 in response to the emission control signal EM.

The sixth transistor T6 may include a first electrode connected to the fourth node N4, a second electrode for receiving the initialization voltage Vint, and a gate electrode for receiving a first bypass signal GB1. The sixth transistor T6 may provide the initialization voltage Vint to the fourth node N4 in response to the first bypass signal GB1.

Similarly, the second pixel 212 may include a second light emitting diode EL2, a second storage capacitor CST2, and six transistors T11 to T16. The second pixel 212 may be substantially the same as the first pixel 211.

The second light emitting diode EL2 may be connected between the first power source (or a fourth node N4) and the second power source. The second light emitting diode EL2 may emit light based on a second driving current flowing through a fourth node N14.

The second transistor T12 may include a first electrode connected to a second data line D2, a second electrode connected to the first node N1, and a gate electrode for receiving a second gate signal GW2. The second transistor T2 may transmit a second data signal DATA2 received from the second data line D2 to the first node N1 in response to the second gate signal GW2.

In some embodiments, the second gate signal GW2 may be different from the first gate signal GW1 that is provided to the first pixel 211. For example, when the first gate signal GW1 and the second gate signal GW2 are the same, the second transistor T2 of the first pixel 211 and the second transistor T12 of the second pixel 212 may be turned on at the same time so that the first data signal DATA1 and the second data signal DATA2 may be provided to the first node N1 at the same time. That is, if the first gate signal GW1 and the second gate signal GW2 are the same, a collision between the first and second data signals DATA1 and DATA2 may occur. Therefore, the second gate signal GW2 does not overlap the first gate signal GW1 to prevent the collision.

The first transistor T11 may include a first electrode connected to the first node N1, a second electrode connected to a second node N12, and a gate electrode connected to a third node N13. The first transistor T11 may control the first driving current applied to the second light emitting diode EL2 in response to a third node voltage (e.g., a voltage charged in the second storage capacitor CST2).

The third transistor T13 may include a first electrode connected to the second node N12, a second electrode connected to the third node N13, and a gate electrode for receiving the second gate signal GW2. The third transistor T13 may electrically connect the second node N12 and the third node N13 in response to the second gate signal GW2.

The second storage capacitor CST2 may be connected between the first power source and the third node N13. The second storage capacitor CST2 may store the second data signal DATA2 provided through the second, first, and third transistors T12, T11, and T13.

The fourth transistor T14 may include a first electrode connected to the initialization voltage line for transmitting the initialization voltage Vint, a second electrode connected to the third node N13, and a gate electrode for receiving a second initialization signal G12. The fourth transistor T14 may transmit the initialization voltage

Vint to the second storage capacitor CST2 (or to the gate electrode of the first transistor T11) in response to the second initialization signal G12. The second initialization signal G12 may be the same as, or different than, the first initialization signal G11.

The fifth transistor T15 may include a first electrode connected to the second node N12, a second electrode connected to the fourth node N14, and a gate electrode for receiving the emission control signal EM. The fifth transistor T5 may form the second current path between the second node N12 and the second light emitting diode EL2 in response to the emission control signal EM. Because the common transistor TC is also turned on by the emission control signal EM, the fifth transistor T15 and the common transistor TC may form the second current path between the first power source and the second light emitting diode EL2 in response to the emission control signal EM.

The sixth transistor T16 may include a first electrode connected to the fourth node N14, a second electrode for receiving the initialization voltage Vint, and a gate electrode for receiving a second bypass signal GB2. The sixth transistor T16 may provide the initialization voltage Vint to the fourth node N14 in response to the second bypass signal GB2.

As described above, the display panel 110 (or the pixel unit 210) may include the first pixel 211, the second pixel 212, and the common transistor TC. The common transistor TC may form the current paths (e.g., the first and second current paths) between the first power source and pixels (e.g., the first and second pixels 211 and 212) in response to the emission control signal EM. Thus, the display panel 110 (or the pixel unit 210) may include fewer components than a typical display panel having 7T1C pixel structure, and a size of the pixel unit may be reduced. Therefore, the number of pixels per unit area (i.e., PPI (pixels per inch)) may be increased, and resolution of the display panel 110 may be improved.

Each of the first pixel 211 and the second pixel 212 includes one capacitor and six transistors in FIG. 2A. However, this is an example, and the first pixel 211 and the second pixel 212 are not limited thereto. For example, the first pixel 211 may include one capacitor and two transistors (e.g., a switching transistor and a driving transistor). In this case, the switching transistor transmits the first data signal to the capacitor in response to the first gate signal, and the driving transistor controls a first current flowing into a light emitting diode in response to a voltage stored in the capacitor.

In some embodiments, the common transistor TC may be included in one of the first and second pixels 211 and 212. Referring to FIG. 2B, the display panel 110 (or a pixel unit 220) may include the second pixel 212 and a third pixel 221. The third pixel 221 may be substantially the same as the first pixel 211. However, the third pixel 221 may further include the common transistor TC.

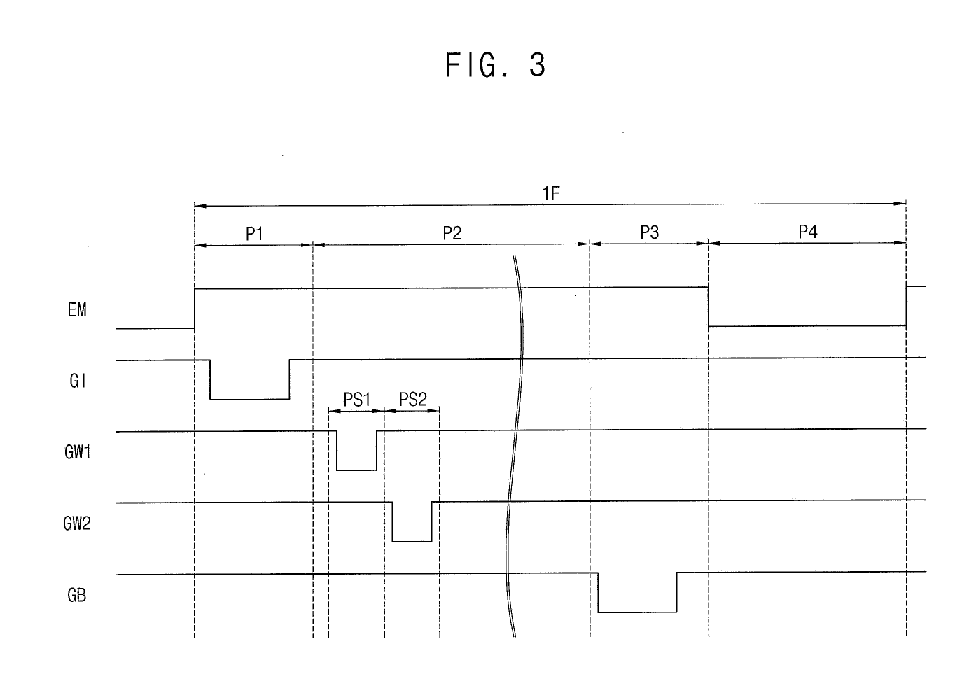

FIG. 3 is a timing diagram for explaining an operation of the pixels of FIG. 2A.

Referring to FIGS. 2A and 3, the first pixel 211 and the second pixel 212 may repeatedly operate in a cycle of one frame 1F (or one frame time). Here, one frame 1F may include first through fourth periods P1 through P4.

In the first period P1, an emission control signal EM may have a logical high level (or may have a high voltage, a high voltage level, or a turn-off level), and an initialization signal GI may have a logical low level (or may have a low voltage, a low voltage level, or a turn-on level). Here, the initialization signal GI may be substantially the same as the first and second initialization signals GI1 and GI2 described with reference to FIG. 2A.

In this, the common transistor TC may be turned off in response to the emission control signal EM having the logical high level. The fourth transistor T4 of the first pixel 211 may be turned on in response to the initializing signal GI having the logical low level, and the first pixel 211 (as well as the first storage capacitor CST1) may be initialized based on the initialization voltage Vint. Similarly, the fourth transistor T14 of the second pixel 212 may be turned on in response to the initialization signal GI having the logical low level, and the second pixel 212 (as well as the second storage capacitor CST2) may be initialized by the initialization voltage Vint.

That is, in the first period P1, the first pixel 211 and the second pixel 212 may be initialized based on the initialization signal GI having the logical low level.

In the second period P2, the emission control signal EM may maintain the logical high level state, and the initialization signal GI may have a logical high level. Further, the first gate signal GW1 and the second gate signal GW2 may have the logical low level (e.g., at some point in the second period P2). For example, the first gate signal GW1 may have the logical low level in a first sub period PS1, and the second gate signal GW2 may have the logical low level in a second sub period PS2. The first and second sub periods PS1 and PS2 may be included in the second period P2, and the second sub period PS2 might not overlap the first sub period PS1.

In the first sub period PS1, the common transistor TC and the fifth transistor T5 of the first pixel 211 may be maintained in the turned off state, and the second transistor T2 of the first pixel 211 and the third transistor T3 of the first pixel 211 may be turned on in response to the first gate signal GW1 having the logical low level. In this case, the first data signal DATA1 may be transferred to the first storage capacitor CST1 through the second transistor T2, the first transistor T1, and the third transistor T3, and the first storage capacitor CST1 may store the first data signal DATA1. That is, the first pixel 211 may store the first data signal DATA1 in response to the first gate signal GW1 having the logical low level in the first sub period PS1. Because a threshold voltage of the first transistor T1 affects the first data signal DATA1, the first pixel 211 (or the display panel 110) may compensate the threshold voltage of the first transistor T1 using a diode connected structure of the first transistor Ti.

Similarly, in the second sub period PS2, the common transistor TC and the fifth transistor T15 of the second pixel 212 may be maintained in the turned off state, and the second transistor T12 of the second pixel 212 and the third transistor T13 of the second pixel 212 may be turned on in response to the second gate signal GW2 having the logical low level. Further, the second transistor T2 of the first pixel 211 and the third transistor T3 of the first pixel 211 may be turned off in response to the first gate signal GW1 having the logical high level in the second sub period PS2. In this case, the second data signal DATA2 may be transferred to the second storage capacitor CST2 through the second transistor T12, the first transistor T11 and the third transistor T13, and the second storage capacitor CST2 may store the second data signal DATA2. That is, the second pixel 212 may store the second data signal DATA2 in response to the second gate signal GW2 having the logical low level in the second sub period PS2.

In other words, in the second period P2, the first pixel 211 may store the first data signal DATA1, and the second pixel 212 may thereafter store the second data signal DATA2.

In the third period P3, the emission control signal EM, the initialization signal GI, and the gate signals GW1 and GW2 may have the logical high level, and the bypass signal GB may have the logical low level. Here, the bypass signal GB may be substantially the same as the first compensation control signal GB1 and the second compensation control signal GB2.

In this case, the fourth transistor T4 and the fifth transistor T5 of the first pixel 211 may maintain the turn off state, and the sixth transistor T6 of the first pixel 211 may be turned on in response to the bypass signal GB having the logical low level. In this case, the fourth node N4 may be initialized based on the initialization voltage Vint, or the fourth node voltage of the fourth node N4 may be transmitted to the outside (e.g., discharged) through a power supply line.

Similarly, the fourth transistor T14 and the fifth transistor T15 of the second pixel 212 may maintain the turn off state, and the sixth transistor T16 of the second pixel 212 may be turned on in response to the bypass signal GB having the logical low level. In this case, the fourth node N14 may be initialized based on the initialization voltage Vint, or the fourth node voltage of the fourth node N14 may be discharged/transmitted to the outside through a power supply line.

That is, the first pixel 211 and the second pixel 212 may initialize the anodes of the light emitting diodes EL1 and EL2 in response to the bypass signal GB, respectively.

In the fourth period P4, the emission control signal EM may have the logical low level, and the initialization signal GI, the gate signals GW1 and GW2, and the bypass signal GB may have the logical high level. In this case, the common transistor TC and the fifth transistor T5 of the first pixel 211 may be turned on in response to the emission control signal EM having the logical low level, and the first current path may be formed between the first power source and the first light emitting diode EL1. The first transistor T1 of the first pixel 211 may control the first driving current flowing through the first current path based on the first data signal DATA1 stored in the first storage capacitor CST1. The first light emitting diode EL1 may emit light with a luminance corresponding to the first driving current.

Similarly, the fifth transistor T15 of the second pixel 212 may be turned on in response to the emission control signal EM having the logical low level, and the second current path may be formed between the first power source and the second light emitting diode EL2. The first transistor T11 of the second pixel 212 may control the second driving current flowing through the second current path based on the second data signal DATA2 stored in the second storage capacitor CST2. The second light emitting diode EL2 may emit light with a luminance corresponding to the second driving current.

Accordingly, tin the fourth period P4, the first pixel 211 may emit light with the luminance corresponding to the first data signal DATA1, and the second pixel 212 may emit light with the luminance corresponding to the second data signal DATA2.

As described above, the first and second pixels 211 and 212 may perform initialization of the first transistors T1 and T11 in the first period P1, storing the data signals DATA1 and DATA2 and compensating the threshold voltage in the second period P2, initializing the anodes of the first and second light emitting diodes EL1 and EL2 in the third period P3, and emitting lights with luminances corresponding to data signals DATA1 and DATA2 in the fourth period P4. The first pixel 211 may store the first data signal DATA1, and the second pixel 212 may then store the second data signal DATA2 (e.g., time division driving).

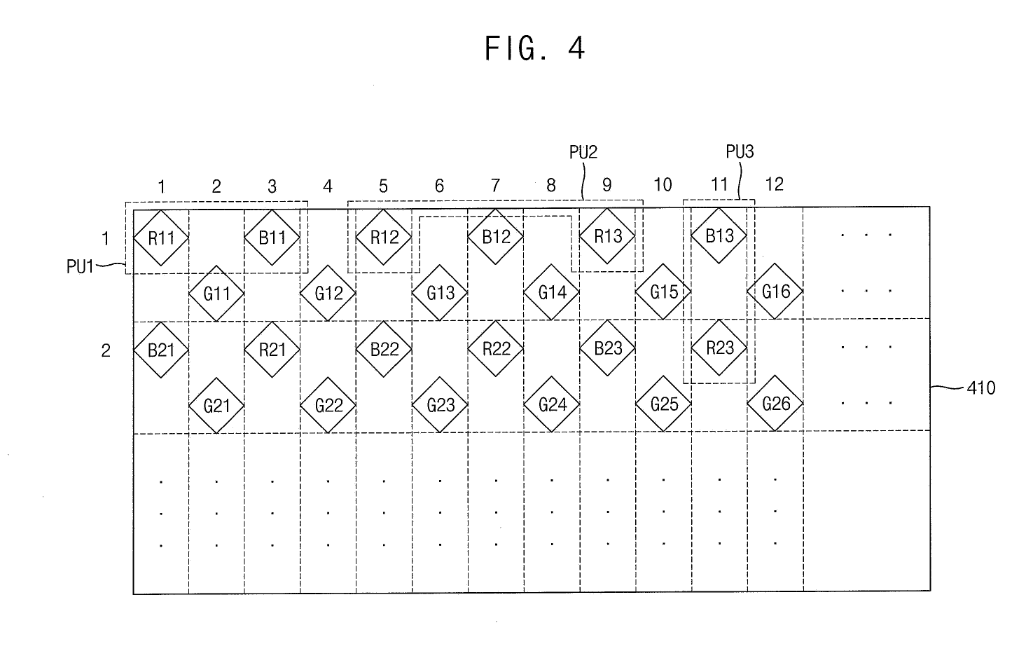

FIG. 4 is a diagram illustrating a display panel included in the display device of FIG. 1.

Referring to FIG. 4, the display panel 410 may include first sub pixels R11, R12, . . . (or first type pixels), second sub pixels G11, G12, . . . (or second type pixels), and third sub pixels B11, B12, . . . (or third type pixels).

The first sub pixels R11, R12, . . . may emit first color light (e.g., red color light), the second sub pixels G11, G12, . . . may emit second color light (e.g., green color light), and the third sub pixels B11, B12, . . . may emit blue color light (e.g., blue color light).

In some embodiments, the first sub pixels R11, R12, . . . , the second sub pixels G11, G12, . . . , and the third sub pixels B11, B12, . . . may be arranged in a pentile form. In some embodiments, the first sub pixels R11, R12, . . . , the second sub pixels G11, G12, . . . , and the third sub pixels B11, B12, . . . may be arranged in a diamond pentile form. For example, the display panel 410 may include sub-pixels repeatedly arranged in RGBG format on one pixel row. For example, a red pixel R11, a blue pixel B11, a blue pixel B21, and a red pixel R21 may be arranged in respective diagonal directions with respect to a green pixel G11 to surround the green pixel G11.

In some embodiments, at least two adjacent pixels in the same pixel row may share the common transistor TC described with reference to FIG. 2A. For example, a first pixel unit PU1 may include the red pixel R11 and the blue pixel B11 in the first pixel row, and the red pixel R11 and the blue pixel B11 may share one common transistor TC. For example, another pixel unit may include the blue pixel B21, the green pixel G21, and the red pixel R21, wherein the blue pixel B21, the green pixel G21, and the red pixel R21 may share another common transistor TC.

In some embodiments, at least two adjacent pixels emitting the same color light in the same pixel row may share the common transistor TC. For example, a second pixel unit PU2 may include a red pixel R12 and a red pixel R13 included in the first pixel row, and the red pixel R12 and the red pixel R13 may share one common transistor TC. The red pixel R13 may be a pixel having the same type closest to the red pixel R12.

As another example, a pixel unit may include a blue pixel B21, a blue pixel B22, and a blue pixel B23 in the second pixel row, and the blue pixels B21, B22, and B23 may share one common transistor TC. Similarly, a pixel unit may include a red pixel R21, a red pixel R22, and a red pixel R23 in the second pixel row, and the red pixels R21, R22, and R23 may share one common transistor TC.

In some embodiments, the pixels in the same pixel column may share the common transistor TC. For example, a third pixel unit PU3 may include a blue pixel B13 and a red pixel R23 in an eleventh pixel column, and the blue pixel B13 and the red pixel R23 may share one common transistor TC. The blue pixel B13 may be included in the first pixel row and the red pixel R23 may be included in the second pixel row that is adjacent the first pixel row. In some embodiments, the third pixel unit PU3 may include the same type of pixels (e.g., pixels that emit the same color light) in the same pixel column.

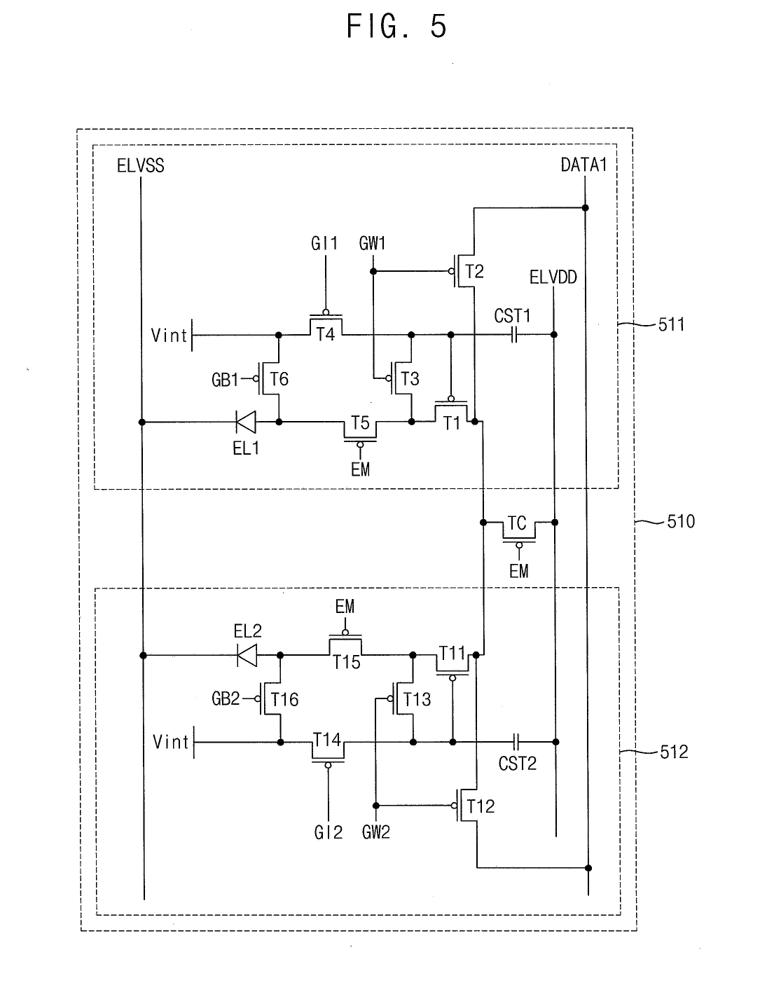

FIG. 5 is a circuit diagram illustrating an example of pixels included in the display panel of FIG. 4.

Referring to FIGS. 2A, 4, and 5, the pixel unit 510 may include a fourth pixel 511, a fifth pixel 512, and a common transistor TC. The pixel unit 510 may be substantially the same as the third pixel unit PU3 of FIG. 4, and the pixel unit 510 may include the blue pixel B13 and the red pixel R23 of FIG. 4.

The common transistor TC, the fourth pixel 511, and the fifth pixel 512 are substantially the same as the common transistor TC, the first pixel 211, and the second pixel 212 described with reference to FIG. 2A, respectively. Thus, duplicated descriptions are not repeated.

The fourth pixel 511 and the fifth pixel 512 may be connected to the same data line. In this case, the fifth pixel 512 may receive the first data signal DATA1 that is also provided to the fourth pixel 511.

However, the fourth pixel 511 may store the first data signal DATA1 in response to the first gate signal GW1, and the fifth pixel 512 may store the first data signal DATA1 in response to the second gate signal GW2. For example, the fourth pixel 511 may store the first data signal DATA1 in the first sub period PS1 described with reference to FIG. 3, and the fifth pixel 512 may store the first data signal DATA1 in the second sub period PS2.

For reference, when the pixels included in the same pixel row share the common transistor TC, on-duty (e.g., on-duty time, or time with logical low level) of the gate signals GW1 and GW2 may be reduced. For example, in the case of the first pixel unit PU1 or the second pixel unit PU2 of FIG. 4, different gate signals GW1 and GW2 may be provided during the second period P2 of FIG. 3. Then, the on-duty of each of the gate signals GW1 and GW2 may be reduced. As the on-duty of each of the gate signals GW1 and GW2 decreases, the pixels might not properly write or store the data signals. Thus, the pixels may emit light with a luminance that is different from the target luminance (for example, the luminance corresponding to the data signal).

If the pixels included in the same pixel column (instead of the same pixel row) share the common transistor TC, the on-duty of the gate signals GW1 and GW2 may not be reduced. Therefore, the pixels may have sufficient time to write the data signal, and can emit light with the target luminance.

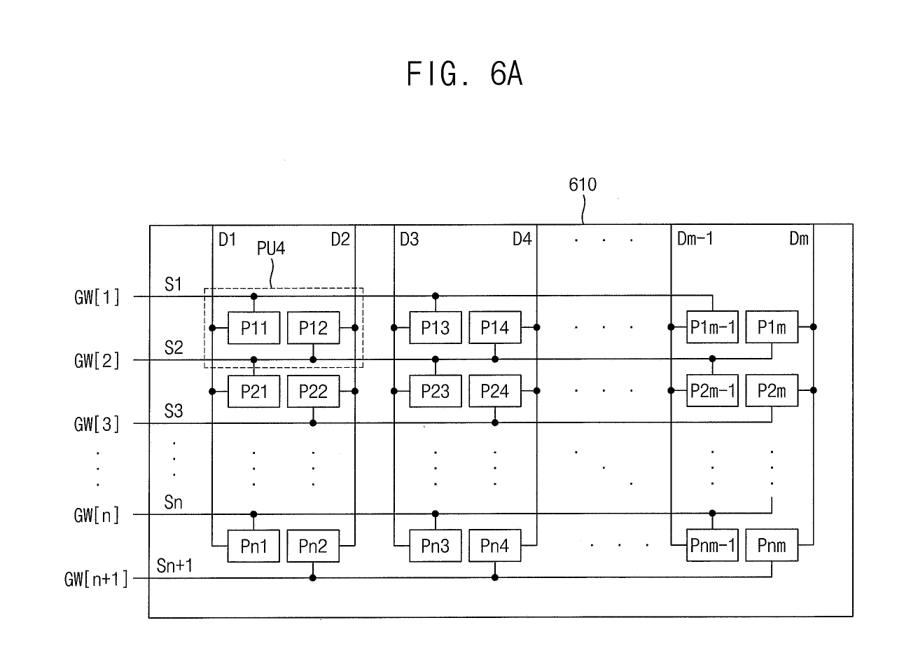

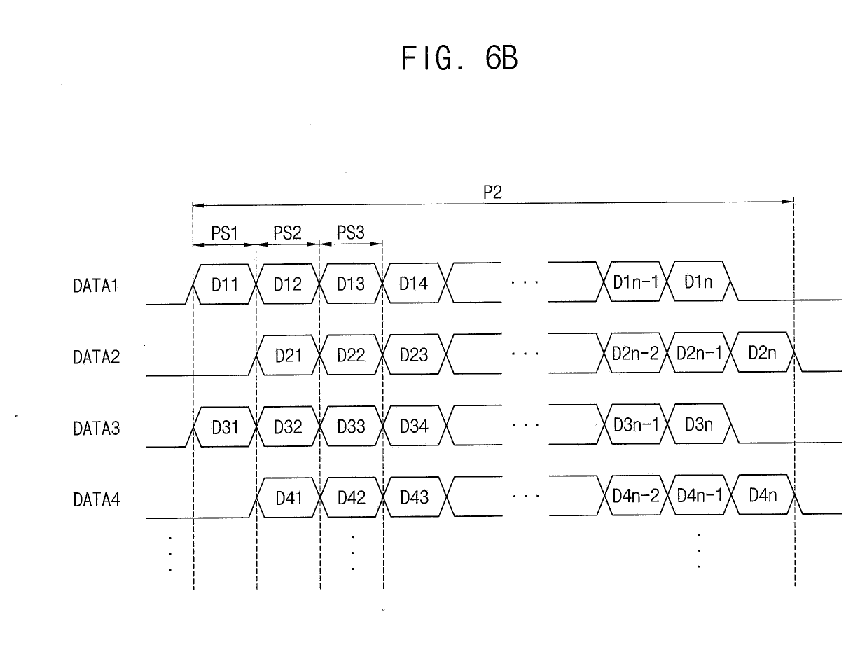

FIG. 6A is a diagram illustrating an example of a connection structure of pixels included in the display panel of FIG. 4. FIG. 6B is a diagram illustrating an example of a data signal provided to the display panel of FIG. 4.

Referring to FIG. 6A, the display panel 610 may include the data lines D1 to Dm, the gate lines S1 to Sn+1, and pixels P11 to Pnm. In comparison with the display panel 110 of FIG. 1, the display panel 610 may further include an (N+1)-th gate line Sn+1.

A fourth pixel unit PU4 may include two pixels (e.g., pixels P11 and P12). For example, the fourth pixel unit PU4 may include two pixels in the same pixel row. One of the two pixels may be connected to a gate line corresponding to the corresponding pixel row (e.g., gate line S1), and the other pixel of the two pixels may be connected to a gate line corresponding to the adjacent pixel row (e.g., gate line S2).

For example, a first pixel P11 included in the first pixel row may be connected to a first gate line 51, and a second pixel P12 included in the first pixel row may be connected to a second gate line S2. In this case, the first pixel P11 may store a first data signal provided through a first data line D1 in response to a first gate signal GW[1] provided through the first gate line 51. Similarly, the second pixel P12 may store a second data signal provided through a second data line D2 in response to a second gate signal GW[2] provided through the second gate line S2. For example, a pixel P21 included in the second pixel row may be connected to the second gate line S2, and a pixel P22 included in the second pixel row may be connected to a third gate line S3. In this case, the pixel P21 may store the first data signal in response to the second gate signal GW[2], and the pixel P22 may store the second data signal in response to a third gate signal GW[3] provided through the third gate line S3.

That is, in an i-th pixel row, an odd pixel (or a pixel included in an odd pixel column) may be connected to an i-th gate line to store the data signal in response to an i-th gate signal provided through the i-th gate line, and an even pixel (or a pixel included in an even pixel column) may be connected to an (i+1)-th gate line to store the data signal in response to an (i+1)-th gate signal, where i is a positive integer.

In some embodiments, the second data signal provided to the even pixel may be delayed by a reference time (e.g., one pixel line time) with respect to the first data signal provided to the odd pixel in the same pixel row. Thus, the data driver 130 may generate the first data signal for the odd pixel, and the second data signal for the even pixel, and may delay the second data signal by the reference time with respect to the first data signal.

Referring to FIG. 6B, the first data signal DATA1 provided form the data driver 130 to the first data line D1 may include data values D11 to D1n for the pixels P11 to Pn1 in the first pixel column. Similarly, the second data signal DATA2 provided from the data driver 130 to the second data line D2 may include data values D21 to D2n for the pixels P12 to Pn2 in the second pixel column. The third data signal DATA3 provided from the data driver 130 to the third data line D3 may include data values D31 to D3n for the pixels P13 to Pn3 in the third pixel column. That is, i-th data signal DATAi provided from the data driver 130 to the i-th data line Di may include data values Di1 to Din for the pixels P1i to Pni in the i-th pixel column.

The first data signal DATA1 may include a data value D11 for a pixel P11 included in the first pixel row in a first sub period PS1 of a second period P2 (described with reference to FIG. 3), and a data value D12 for a pixel P21 include in the second pixel row in a second sub period PS2 of the second period P2. The second data signal DATA2 may include a data value D21 for a pixel P12 included in the first pixel row in the second sub period PS2, and a data value D22 for a pixel P22 included in the second pixel row in a third sub period PS3.

That is, the second data signal DATA2 may be delayed by one sub period (for example, the first sub period PS1) from the first data signal DATA1. Similarly, the third data signal DATA3 may have the same timing (or phase) as the first data signal DATA1, and the fourth data signal DATA4 may be delayed be one sub period from the first data signal DATA1 (or from the third data signal DATA3).

In this case, the pixels in the even pixel columns may normally store or write corresponding data signals (e.g., data values D21, D42, . . . ) in response to the gate signals (e.g., the (i+1)-th gate signal) corresponding to adjacent pixel row.

As described above, the fourth pixel unit PU4 may include two pixels, the first pixels in the odd pixel columns may be connected to gate lines of the corresponding pixel row, and the second pixels in the even pixel columns may be connected to gate lines of the adjacent pixel row. The data driver 130 may output the second data signal for the second pixels (e.g., the even data lines) delayed by the reference time (e.g., the sub period time) from the first data signal for the first pixels (e.g., the odd data lines). Thus, the display panel 110 including the fourth pixel unit PU4 may prevent, reduce, or minimize decrease of the data writing time for each pixel (e.g., decrease of on-duties of the gate signals).

The present embodiments may be applied to any display device and any system including the display device. For example, the present embodiments may be applied to a television, a computer monitor, a laptop, a digital camera, a cellular phone, a smart phone, a smart pad, a personal digital assistant (PDA), a portable multimedia player (PMP), a MP3 player, a navigation system, a game console, a video phone, etc.

The foregoing is illustrative of embodiments, and is not to be construed as limiting thereof. Although a few embodiments have been described, those skilled in the art will readily appreciate that many modifications are possible in the embodiments without materially departing from the novel teachings and advantages of embodiments. Accordingly, all such modifications are intended to be included within the scope of embodiments as defined in the claims. In the claims, means-plus-function clauses are intended to cover the structures described herein as performing the recited function and not only structural equivalents but also equivalent structures. Therefore, it is to be understood that the foregoing is illustrative of embodiments and is not to be construed as limited to the specific embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A display panel, comprising:
a first pixel including a first light emitting diode for emitting light based on a first current received from a first power voltage;
a second pixel including a second light emitting diode for emitting light based on a second current received from the first power voltage; and
a common transistor forming a first current path through which the first current flows between a first power source for supplying the first power voltage and the first light emitting diode, and forming a second current path through which the second current flows between the first power source and the second light emitting diode, in response to an emission control signal.

2. The display panel of claim 1, wherein the first pixel includes:
a first storage capacitor;
a first transistor to control the first current applied to the first light emitting diode in response to a voltage stored in the first storage capacitor; and
a second transistor to transmit a first data signal to the first storage capacitor in response to a first gate signal.

3. The display panel of claim 2, wherein the first pixel further includes:
a third transistor including a first electrode connected to a second electrode of the first transistor, a second electrode connected to an end of the first storage capacitor, and a gate electrode for receiving the first gate signal;
a fourth transistor including a first electrode for receiving an initialization voltage, a second electrode connected to the end of the first storage capacitor, and a gate electrode for receiving a first initialization signal;
a fifth transistor including a first electrode connected to the second electrode of the first transistor, a second electrode connected to an anode electrode of the first light emitting diode, and a gate electrode for receiving the emission control signal; and
a sixth transistor including a first electrode connected to the anode electrode of the first light emitting diode, a second electrode for receiving the initialization voltage, and a gate electrode for receiving a first bypass signal,
wherein the second transistor includes a first electrode for receiving the first data signal, a second electrode connected to a first electrode of the first transistor, and a gate electrode for receiving the first gate signal, and
wherein the common transistor includes a first electrode connected to the first power source, a second electrode connected to the first electrode of the first transistor, and a gate electrode for receiving the emission control signal.

4. The display panel of claim 2, wherein the second pixel further includes:
a second storage capacitor;
a first transistor to control the second current applied to the second light emitting diode in response to a voltage stored in the second storage capacitor; and
a second transistor to transmit a second data signal to the second storage capacitor in response to a second gate signal,
wherein the second gate signal is different from the first gate signal.

5. The display panel of claim 4, wherein the first pixel and the second pixel are included in the same pixel row,
wherein the first light emitting diode of the first pixel emits first color light, and
wherein the second light emitting diode of the second pixel emits second color light that is different from the first color light.

6. The display panel of claim 4, wherein the first pixel and the second pixel are included in the same pixel row,
wherein the first light emitting diode and the second light emitting diode emit light of a first color.

7. The display panel of claim 4, wherein the first pixel and the second pixel are included in a first pixel row,
wherein the first gate signal is provided to the first pixel through a first gate line, and
wherein the second gate signal is provided to the second pixel through a second gate line that is different from the first gate line.

8. The display panel of claim 7, wherein the first gate line corresponds to the first pixel row, and
wherein the second gate line corresponds to a second pixel row that is adjacent to the first pixel row.

9. The display panel of claim 4, wherein the first pixel and the second pixel are included in a first pixel column, and
wherein the first data signal and the second data signal are transmitted through a first data line corresponding to the first pixel column.

10. The display panel of claim 1, further comprising a third pixel including a third light emitting diode for emitting light based on a third current received from the first power voltage,
wherein the common transistor forms a third current path through which the third current flows between the first power source and the third light emitting diode in response to the emission control signal.

11. A display device, comprising:
a display panel including:
a first pixel having a first light emitting diode for emitting light based on a first current corresponding to a first data signal;
a second pixel having a second light emitting diode for emitting light based on a second current corresponding to a second data signal; and
a common transistor;
a data driver to provide the first data signal to the first pixel, and to provide the second data signal to the second pixel; and
a gate driver to provide a first gate signal to the first pixel, to provide a second gate signal to the second pixel, and to provide an emission control signal to the common transistor,
wherein the common transistor forms a first current path through which the first current flows between a first power source of a first power voltage and the first light emitting diode, and forms a second current path through which the second current flows between the a first power source and the second light emitting diode, in response to the emission control signal.

12. The display device of claim 11, wherein the first pixel includes:
a first storage capacitor;
a first transistor to control the first current applied to the first light emitting diode in response to a voltage stored in the first storage capacitor; and
a second transistor to transmit the first data signal to the first storage capacitor in response to the first gate signal.

13. The display device of claim 12, wherein the first pixel further includes:
a third transistor including a first electrode connected to a second electrode of the first transistor, a second electrode connected to an end of the first storage capacitor, and a gate electrode for receiving the first gate signal;
a fourth transistor including a first electrode for receiving an initialization voltage, a second electrode connected to the end of the first storage capacitor, and a gate electrode for receiving a first initialization signal;
a fifth transistor including a first electrode connected to the second electrode of the first transistor, a second electrode connected to an anode electrode of the first light emitting diode, and a gate electrode for receiving the emission control signal; and
a sixth transistor including a first electrode connected to the anode electrode of the first light emitting diode, a second electrode for receiving the initialization voltage, and a gate electrode for receiving a first bypass signal,
wherein the second transistor includes a first electrode for receiving the first data signal, a second electrode connected to a first electrode of the first transistor, and a gate electrode for receiving the first gate signal, and
wherein the common transistor includes a first electrode connected to the first power source, a second electrode connected to the first electrode of the first transistor, and a gate electrode for receiving the emission control signal.

14. The display device of claim 12, wherein the second pixel further includes:
a second storage capacitor;
a first transistor to control the second current applied to the second light emitting diode in response to a voltage stored in the second storage capacitor; and
a second transistor to transmit the second data signal to the second storage capacitor in response to the second gate signal,
wherein the second gate signal is different from the first gate signal.

15. The display device of claim 14, wherein the first pixel and the second pixel are included in the same pixel row,
wherein the first light emitting diode of the first pixel emits light of a first color, and
wherein the second light emitting diode of the second pixel emits light of a second color that is different from the first color.

16. The display device of claim 14, wherein the first pixel and the second pixel are included in the same pixel row,
wherein the first light emitting diode and the second light emitting diode emit light of a first color.

17. The display device of claim 14, wherein the first pixel and the second pixel are included in a first pixel row,
wherein the first gate signal is provided to the first pixel through a first gate line, and
wherein the second gate signal is provided to the second pixel through a second gate line that is different from the first gate line.

18. The display device of claim 17, wherein the data driver is for outputting the second data signal by delaying the second data signal by a reference time with respect to the first data signal.

19. The display device of claim 14, wherein the first pixel and the second pixel are included in a first pixel column, and
wherein the first data signal and the second data signal are transmitted through a first data line corresponding to the first pixel column.

20. The display device of claim 11, wherein the display panel further includes a third pixel including a third light emitting diode for emitting light based on a third current received from the first power voltage, and
wherein the common transistor forms a third current path through which the third current flows between the first power source and the third light emitting diode in response to the emission control signal.
